(19) United States
(12) Patent Application Publication
(10) Pub. No.: US 2010/0183910 A1
(43) Pub. Date: Jul. 22, 2010

(54) BATTERY PACK AND BATTERY-MOUNTED DEVICE

(76) Inventors: Hajime Nishino, Nara (JP); Yusuke Sato, Osaka (JP); Yasushi Hirakawa, Osaka (JP)

Correspondence Address: MCDERMOTT WILL & EMERY LLP, 600 13TH STREET, NW, WASHINGTON, DC, 20005-3096, US

(21) Appl. No.: 12/663,654

(22) PCT Filed: Jun. 11, 2008
(86) PCT No.: PCT/JP2008/001490

§ 371 Date: Dec. 8, 2009

(30) Foreign Application Priority Data
Jun. 11, 2007 (JP) 2007-153597
Jun. 4, 2008 (JP) 2008-147113

(51) Int. Cl. H01M 2/02

(52) U.S. Cl. 429/163

(57) ABSTRACT

A battery pack is provided in which battery characteristics are not degraded in normal use and, even if a cell reaches a high temperature and a high-temperature gas is released from the inside of the cell, the spread of combustion to the entire pack can be suppressed to reduce damage. The battery pack is provided with cells, a housing for accommodating the cells and a thermal expansion section capable of reducing internal clearances between the cells and the housing upon the application of heat.

### FIELD OF THE INVENTION

The present invention relates to a battery pack used as a power supply of an electronic device or the like and particularly to a battery pack ensured with safety.

### BACKGROUND OF THE INVENTION

In recent years, with the diversification of electronic devices, there has been a demand for cells and battery packs with high capacity, high voltage, high output and high safety. Particularly, in order to provide safe cells and battery packs, cells are generally provided with a PTC or a temperature fuse for preventing a battery temperature rise and a protector for sensing an internal pressure of the cell to cut off a current and battery packs are mounted with a safety circuit and the like.

A construction for inserting a heat insulating material into a pack from a perspective different from safety is disclosed. Specifically, since the temperature of a cell built in a pack is equal to ambient temperature, there is a drawback that battery characteristics are reduced when ambient temperature is low. Accordingly, for the purpose of improving the above drawback, it is proposed in patent literature 1 to provide a pack whose characteristics are not reduced in use without being dependent on ambient temperature by inserting a heat insulating material into the pack to insulate cells from the ambient temperature.

However, the conventional technology using the heat insulating material aims to maintain the temperature of the cells under a low-temperature environment and, if the cells are used in a temperature region equal to or higher than room temperature, normal heat release is not performed because the heat insulating material is installed and battery characteristics may be degraded due to a temperature rise around the cells.

Patent Literature 1: Japanese Unexamined Patent Publication No. H05-234573

### SUMMARY OF THE INVENTION

An object of the present invention is to provide a battery pack with enhanced safety at the time of an abnormality without degrading battery characteristics even if temperature around the cells rises.

In order to solve the above object, one aspect of the present invention is directed to a battery pack, comprising cells; a housing for accommodating the cells; and a thermal expansion section capable of reducing internal clearances between the cells and the housing upon the application of heat.

Another aspect of the present invention is directed to a battery-mounted device having the above battery pack mounted therein.

According to the present invention, even if temperature around the cells rises, safety in the event of an abnormality can be improved without degrading battery characteristics.

### BRIEF DESCRIPTION OF THE DRAWINGS

FIG. 1 is a perspective view showing the construction of a battery pack according to one embodiment of the invention,

FIG. 2 is a section along II-II of the battery pack shown in FIG. 1,

FIG. 3 is a diagram showing a modification of the construction of the battery pack used in the description of the embodiment,

FIG. 4 is a diagram showing a second modification of the construction of the battery pack used in the description of the embodiment,

FIG. 5 is a diagram showing a third modification of the construction of the battery pack used in the description of the embodiment,

FIG. 6 is a schematic section showing an exemplary construction of a cell shown in FIG. 1.

FIG. 7 is a diagram showing a schematic construction of an assembled battery as shown in FIG. 1,

FIG. 8 is a diagram showing temperature measurement positions of a nail penetration test,

FIG. 9 is a perspective view showing the entire construction of a notebook personal computer mounted with a battery pack,

FIG. 10 is an exploded perspective view of the battery pack of FIG. 9,

FIG. 11 is a section along XI-XI of FIG. 9,

FIG. 12 is a section along XII-XII of FIG. 11,

FIG. 13 is a side view showing the entire construction of an electric bicycle mounted with a battery pack,

FIG. 14 is an exploded perspective view of the battery pack of FIG. 13,

FIG. 15 is a section along XV-XV of FIG. 14,

FIG. 16 is a side view showing the entire construction of a hybrid car mounted with a battery pack,

FIG. 17 is an exploded perspective view of the battery pack of FIG. 16, and

FIG. 18 is a section along XVIII-XVIII of FIG. 17.

### BEST MODES FOR EMBODYING THE INVENTION

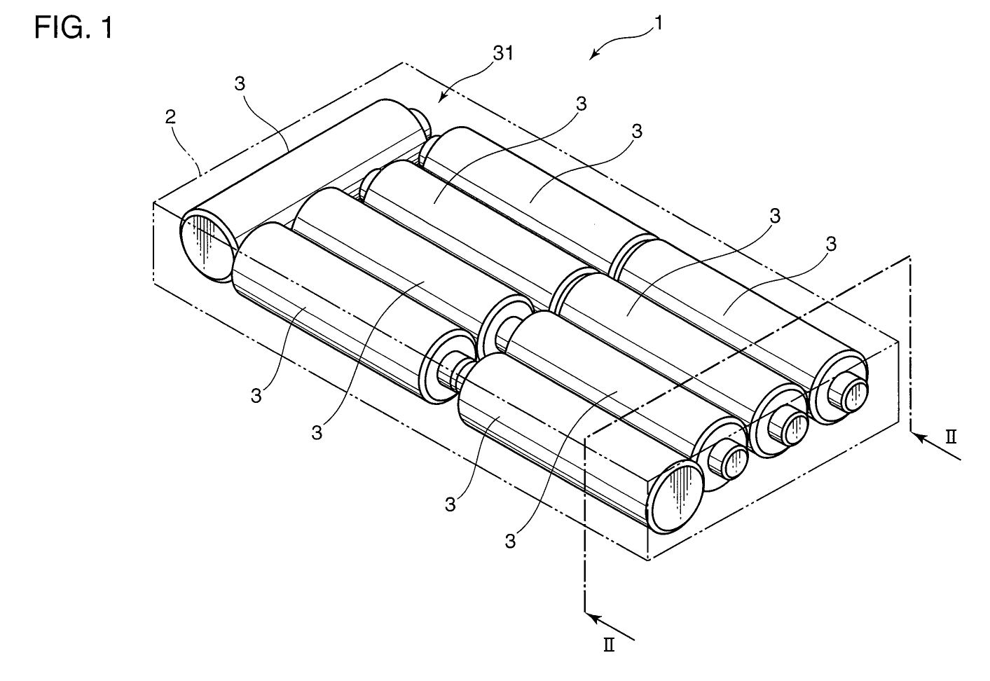

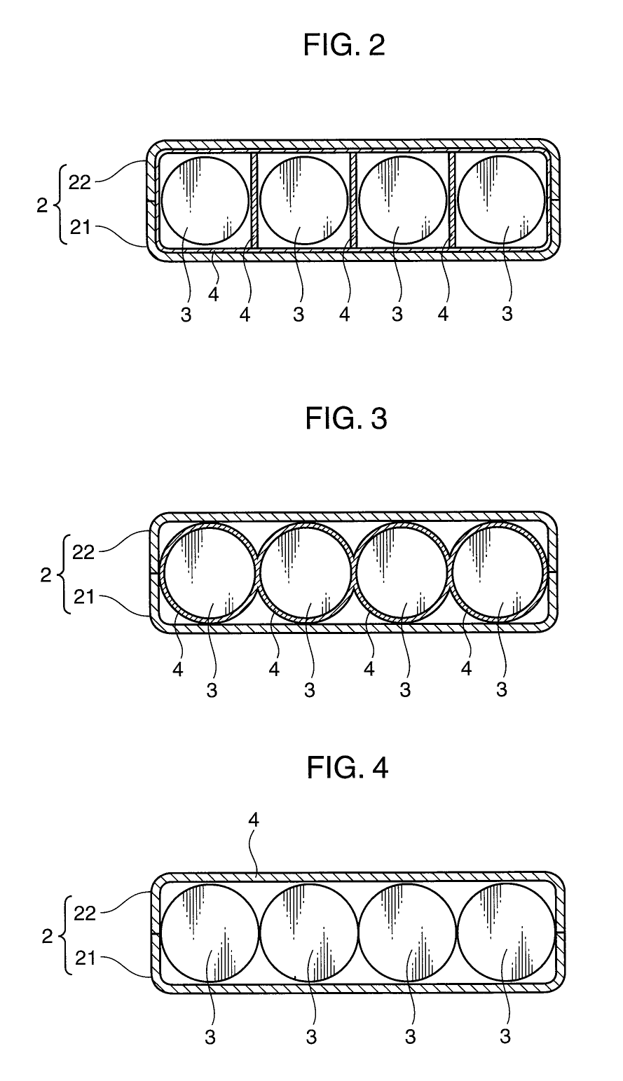

Hereinafter, embodiments of the present invention are described with reference to the drawings. FIG. 1 is a perspective view showing the construction of a battery pack according to one embodiment of the present invention. FIG. 2 is a section along II-II of the battery pack shown in FIG. 1. A battery-mounted device according to one embodiment of the present invention is, for example, an electronic device such as a portable personal computer or a video camera, a power tool such as an electric tool, a vehicle such as a four-wheel vehicle or a two-wheel vehicle or another battery-mounted device mounted with the battery pack 1 shown in FIG. 1 and using it as a power supply.

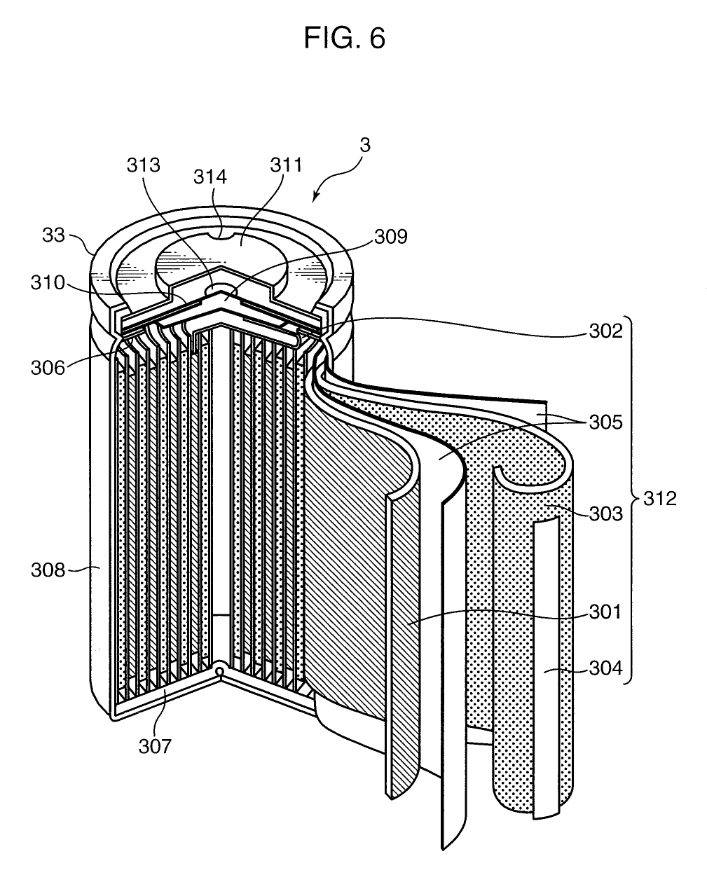

The battery pack 1 shown in FIG. 1 is provided with an assembled battery 31 formed by connecting a plurality of cylindrical cells 3 described in detail with reference to FIG. 6, a safety control circuit (not shown) for ensuring safety by controlling charge and discharge and a substantially box-shaped housing 2 (accommodating chamber) for accommodating the assembled battery 31 and the safety control circuit inside. The housing 2 includes a battery accommodating part 21 and a battery pack lid 22.

A thermal expansion material 4 is mounted between the inner walls of the housing 2, i.e. the inner walls of the battery accommodating part 21 and the battery pack lid 22, and the cells and between the cells. The battery accommodating part 21 and the battery pack lid 22 are made of, for example, metal as a noncombustible material such as iron, nickel, aluminum, titanium; copper or stainless steel, heat resistant resin such as crystalline wholly aromatic polyester, polyethersulfone or aromatic polyamide, or laminated bodies of metal and resin. By sealing an opening of the battery accommodating part 21 by the battery pack lid 22, the housing 2 substantially in the form of a rectangular box is constructed.

On the other hand, the housing 2 is generally in the form of a rectangular box due to easier accommodation into a device housing and easier mounting since the battery pack 1 is used by being accommodated in the housing of the battery-mounted device or mounted on an outer wall of the battery-mounted device. Then, the cells 3 are cylindrical and the housing 2 is rectangular. Thus, if the cylindrical cells 3 are accommodated into the rectangular housing 2, clearances are formed between the cells 3 and the inner walls of the housing 2 because of different shapes. As a result, heat is easily transferred by air convection via these clearances in the housing 2 in the event of abnormal heat generation. However, since the thermal expansion material 4 is mounted between the inner walls of the housing 2 and the cells 3 in the battery pack 1 shown in FIGS. 1 and 2, an abnormally heated cell can be thermally separated by reducing the clearances in the housing in the event of abnormal heat generation.

In the battery pack 1 formed as described above, even if the cell 3 generates heat due to an internal short circuit or overcharge and a gas is released from the inside of the cell 3, the spread of combustion to the housing and other cells can be suppressed to reduce the damage of the battery pack 1 since this cell 3 is thermally separated by the thermal expansion material 4. Although the thermal expansion material 4 is provided between the inner walls of the housing 2 and the cells 3 in the shown example, they may be, for example, so arranged as to cover the cells 3 while being held in close contact with the outer circumferential surfaces of the cells 3 arranged in the housing 2 as shown in FIG. 3.

In addition to being made of resin using a thermal decomposition material as filler, the thermal expansion material may be in the form of paint, tape, clay or putty to be easily mounted on the cell surfaces and the housing surfaces. Particularly upon being mounted on the cell surfaces, the thermal expansion material has better thermal conductivity as adhesion increases, wherefore an effect of suppressing the spread of combustion is increased.

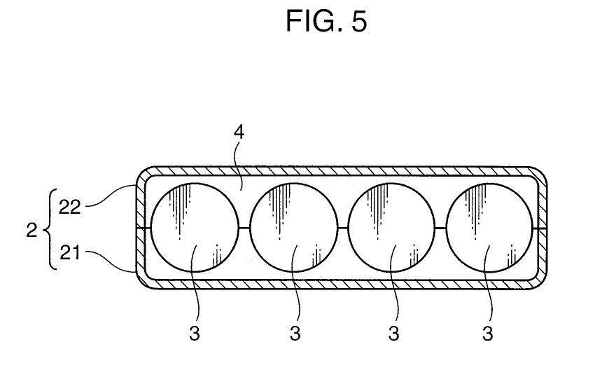

Although the example in which the thermal expansion material 4 is provided between the inner walls of the housing 2 and the cells 3 and the example in which the thermal expansion material 4 is so mounted as to cover the cells 3 while being held in close contact with the outer circumferential surfaces of the cells 3 arranged in the housing 2 in this embodiment, the thermal expansion material 4 needs not always be mounted as in the above examples. For example, a composite material with the thermal expansion material 4 may be used as the material of the housing 2 as shown in FIG. 4 or thermal expansion material may be arranged in clearances in the housing as shown in FIG. 5.

It is sufficient for the thermal expansion material 4 to thermally separate the cell whose temperature has risen by reducing the clearances in the housing 2, and the material thereof is not restricted. For example, a material having a heat resistance, a thermal expansion property and an endothermic property such as Fire Barrier (moldable putty MPP-4S) produced by Sumitomo 3M Ltd., a thermally expandable fire resistance material such as Fiblock produced by Sekisui Chemical Co., Ltd. or an Accera Coat F produced by Access Co., Ltd, a material obtained by mixing expandable graphite in rubber or resin or a ceramic fiber composite material having a thermal expansion property and a fire resistance can be used as a preferable material.

By using such thermal expansion material 4, even if the cell 3 generates heat or a high-temperature gas is generated in the cell 3 due to an internal short circuit or overcharge, the thermal expansion material 4 expands to reduce the clearances in the housing 2. As a result, the cell 3 whose temperature has risen can be thermally separated to suppress the spread of composition to the housing 2 and adjacent normal cells 3, whereby the damage of the battery pack 1 can be suppressed to a minimum level.

Although a plurality of cylindrical cells 3 are accommodated in the housing 2 in the battery pack 1, the shape of the cells is not limited to the cylindrical shape or one cell 3 may be accommodated in the housing 2. In the battery pack 1 in which the plurality of cells 3 are accommodated in the housing 2, even if any one of the cells 3 generates heat due to an internal short circuit or overcharge and a high-temperature gas is released from this cell 3, the surrounding of this cell 3 is thermally separated, wherefore the damage of the cells 3 other than the heated cell 3 can be reduced.

FIG. 6 is a schematic section showing an exemplary construction of the cell 3. The cell 3 shown in FIG. 6 is a nonaqueous electrolyte secondary cell including a polar plate group in a winding structure, e.g. a cylindrical lithium ion secondary cell of 18650 size. The polar plate group 312 is such that a positive plate 301 with a positive electrode lead current collector 302, a negative plate 303 with a negative electrode lead current collector 304 are coiled with a separator 305 held therebetween. An upper insulating plate 306 is mounted on the top of the polar plate group 312 and a lower insulating plate 307 is mounted on the bottom of the polar plate group 312. A case 308 containing the polar plate group 312 and an unillustrated nonaqueous electrolyte is sealed by a gasket 309, a sealing plate 310 and a positive electrode terminal 311.

The positive plate 301 shown in FIG. 6 is formed by substantially uniformly applying a cathode active material to the outer surface of the positive electrode current collector 302. The cathode active material includes a transition-metal containing composite oxide containing lithium, e.g. transition-metal containing composite oxide containing LiCoO₂, LiNiO₂ or the like used in nonaqueous electrolyte secondary cells. Among these transition-metal containing composite oxides, the one in which Co is partly substituted by another element and which enables the use of a high charge end voltage and enables an additive to form a good film by adsorbing or decomposing the surface thereof in a high-voltage state is preferable. Specifically, transition-metal containing composite oxides expressed, for example, by a general expression LiₐM_{b}Ni_{c}Co_{d}Oₑ (M is at least one metal selected from a group of Al, Mn, Sn, In, Fe, Cu, Mg, Ti, Zn and Mo, 0<a<1.3, 0.02≦b≦0.5, 0.02≦d/c+d≦0.9, 1.8<e<2.2, b+c+d=1, and 0.34<c) can be cited as such. Particularly, M is preferably at least one metal selected from a group of Cu and Fe in the above general expression.

The negative plate 303 shown in FIG. 6 is formed by substantially uniformly applying a cathode active material to the outer surface of the negative electrode current collector 304 made of, for example, a metal foil such as an aluminum foil.

A carbon material, a lithium-containing composite oxide, a material capable of alloying with lithium, a material capable of reversibly storing and releasing lithium or a metallic lithium can be used as the cathode active material. For example, cokes, pyrolytic carbons, natural graphites, artificial graphites, mesocarbon microbeads, graphitized mesophase spherules, vapor-growth carbons, glasslike carbons, carbon fibers (polyacrylonitrile based, pitch based, cellulose based, vapor-growth carbon based), amorphous carbons, carbon materials obtained by calcining organic matters and the like can be cited as the carbon material. These may be singly used or two or more of these may be used by being mixed. Among these, graphite materials such as carbon materials obtained by graphitizing mesophase spherules, natural graphites and artificial graphites are preferable. For example, Si or compounds of Si and O (SiOₓ) can be cited as the materials capable of alloying with lithium. These may be singly used or two or more of these may be used by being mixed. By using a silicon-containing cathode active material as described above, a nonaqueous electrolyte secondary cell with a higher capacity can be obtained.

A substantially circular groove 313 is formed substantially in the center of the sealing plate 310. When a gas is produced in the case 308 and an internal pressure exceeds a specified pressure, the groove 313 is broken to release the gas in the case 308. Further, a projection for external connection is provided substantially in the central part of the positive electrode terminal 311, and an electrode opening 314 (release port) is formed in this projection, so that the gas released by breaking the groove 313 is released to the outside of the cell 3 through the electrode opening 314.

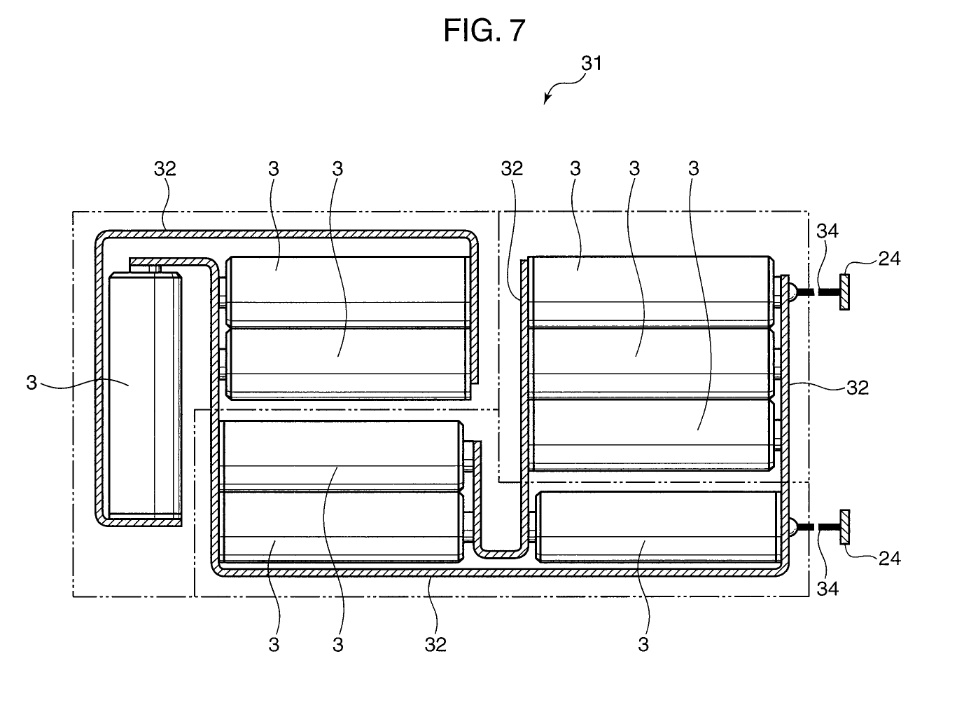

FIG. 7 is a diagram showing a schematic construction of the assembled battery 31. The assembled battery 31 shown in FIG. 7 is constructed by using nine cells arranged such that three sets are connected in series with each set of three cells 3 arranged in parallel. Connection plates 32 and the respective cells 3 are connected, for example, by welding. Sheet-like cell can insulators 33 (see FIG. 6) are wound around the respective cells 3 to insulate the cells 3 from each other.

The opposite ends of a circuit thus formed by the nine cells 3 are respectively connected with two battery pack terminals 24 via connection leads 34.

If the cell 3 is formed by spirally winding the polar plate group 312 as shown in FIG. 6, it becomes easier to obtain a compact shape while increasing a polar plate area. Thus, it is generally prevalent to form the cell 3 by spirally winding the polar plate group 312. If the cell 3 is formed by spirally winding the polar plate group 312 in this way, the cell 3 inevitably comes to have a cylindrical shape.

A modification of the battery pack and a device mounted with the battery pack are described below.

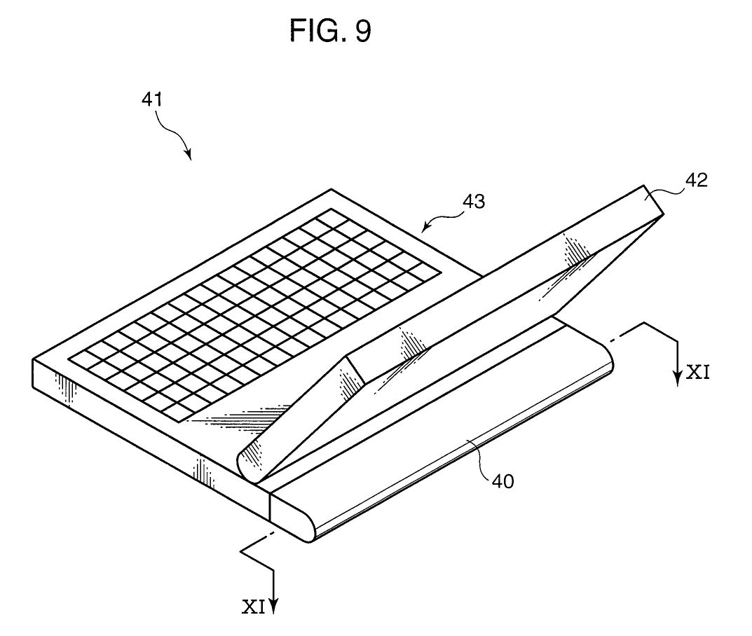

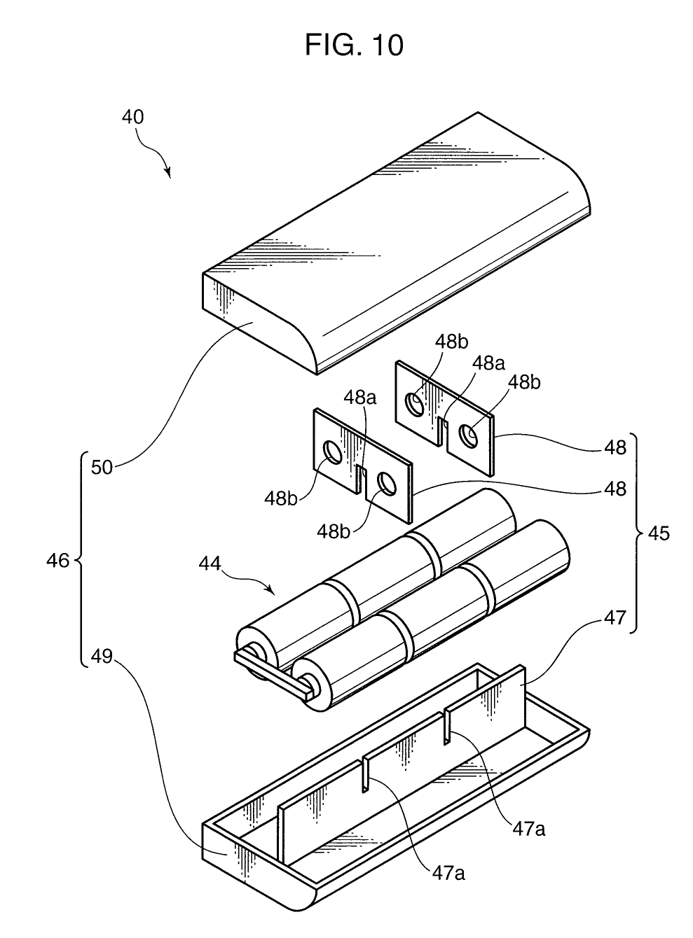

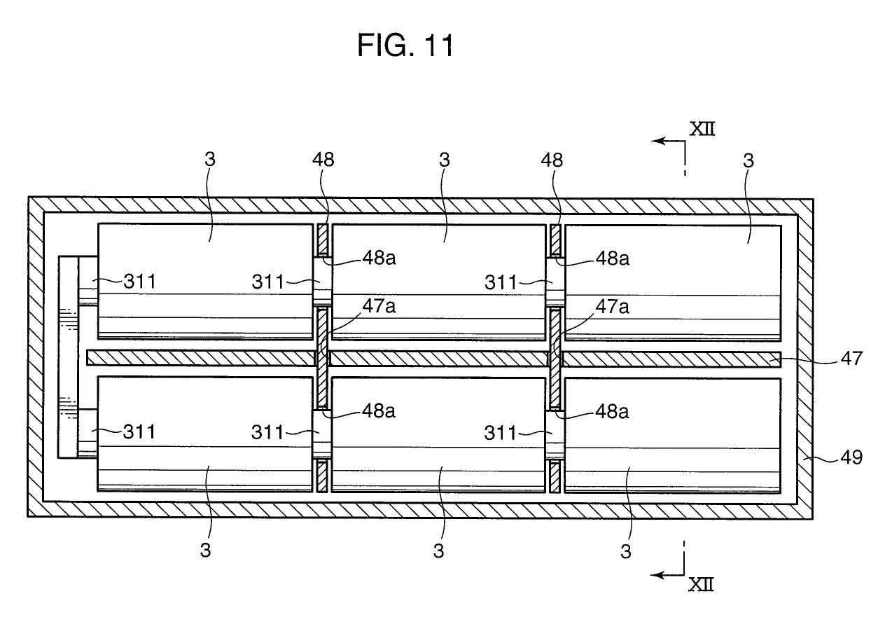

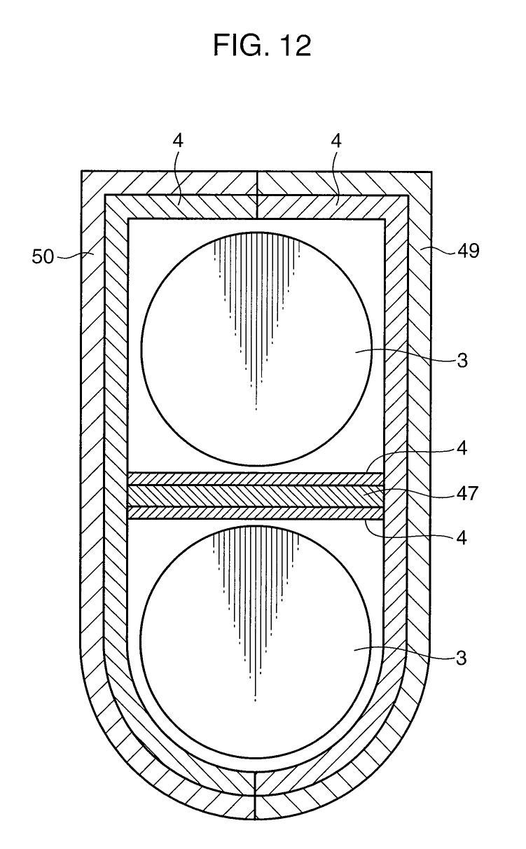

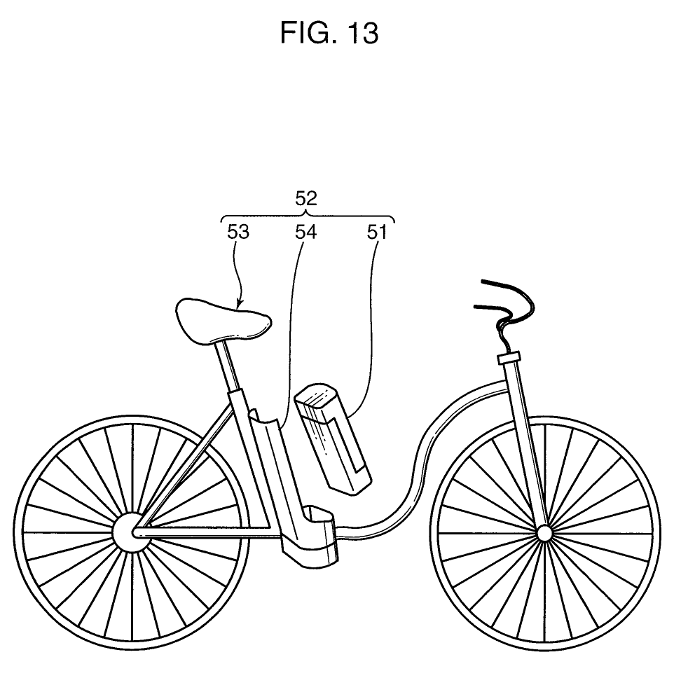

FIG. 9 is a perspective view showing the entire construction of a notebook personal computer 41 mounted with a battery pack 40. FIG. 10 is an exploded perspective view of the battery pack 40. FIG. 11 is a section along XI-XI of FIG. 9. FIG. 12 is a section along XII-XII of FIG. 11.

As shown in FIGS. 9 to 12, the notebook personal computer 41 is provided with computer body 43 including a display 42 and the battery pack 40 mounted in a rear part of this computer body 43.

The battery pack 40 is provided with an assembled battery 44 as an assembly of six cells 3, a cell partition wall 45 for partitioning between the respective cells 3, and a housing 46 for accommodating the assembled battery 44 and the cell partition wall 45.

The assembled battery 44 is such that two sets are connected in parallel with each set of three cells 3 connected in series.

The cell partition wall 45 includes a first partition plate 47 to be arranged between the sets of the cells 3 and a pair of second partition plates 48, 48 to be arranged between the cells connected in series. The second partition plates 48, 48 are respectively assembled in a direction orthogonal to the first partition plate 47.

Specifically, the first partition plate 47 includes slits 47a, 47a formed at two positions spaced apart in a longitudinal direction. Each second partition plate 48 includes a slit 48a in a longitudinal central part. By assembling the first partition plate 47 and the second partition plates 48 by engaging the slits 48a with the respective slits 47a, 47a, the cell partition wall 45 for dividing the interior of the housing 46 into six sections is formed.

Each second partition plate 48 also includes a pair of through holes 48b, 48b formed at the opposite sides of the slit 48a. These through holes 48b, 48b are respectively for permitting the passage of the positive electrode terminal 311 of the cells 3 to bring the positive electrodes 311 of the cells 3 into contact with the negative electrode terminals of the adjacent cells 3.

The housing 46 includes a battery accommodating part 49 and a battery pack lid 50. The battery accommodating part 49 and the battery pack lid 50 are respectively in the form of bottomed containers and assembled with the opening ends thereof held in contact, thereby being able to accommodate the assembled battery 44 and the cell partition wall 45.

As shown in FIG. 12, thermal expansion material 4 is respectively attached to the inner walls of the battery accommodating part 49 and the battery pack lid 50 and the outer surfaces of the cell partition wall 45 in the battery pack 40.

Also in the battery pack 40, even if the cell 33 generates heat due to an internal short circuit or overcharge and a gas is released from the interior of the cell 3, the spread of combustion to the housing 46 and the other cells 3 can be suppressed and the damage of the battery pack 40 can be reduced since this cell 3 is thermally separated by the thermal expansion material 4.

A modification of the battery pack and an electrically assisted bicycle mounted with such a battery pack are described below.

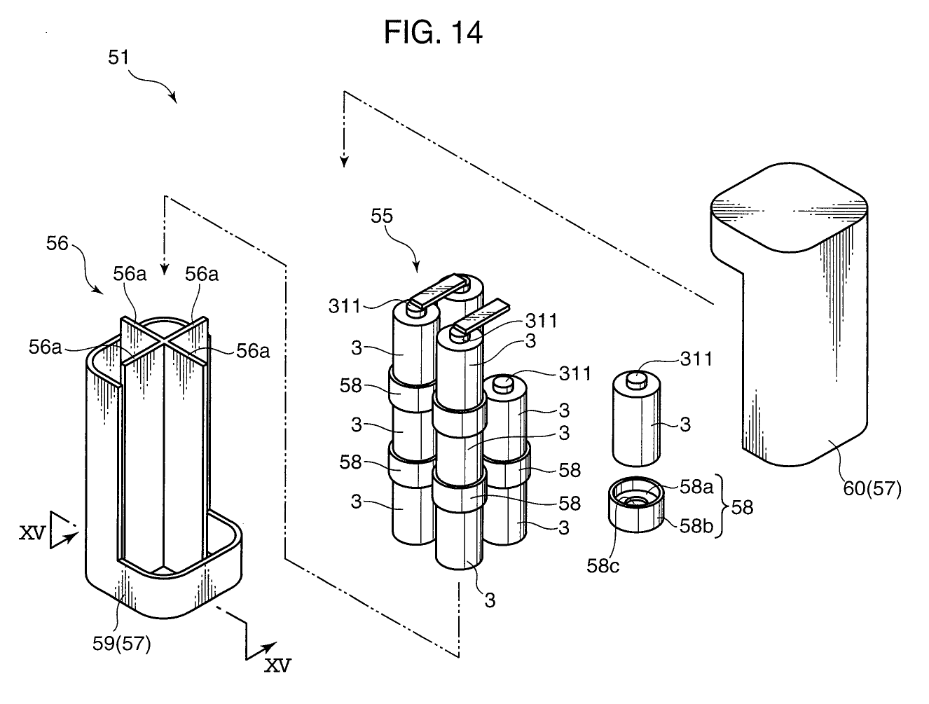

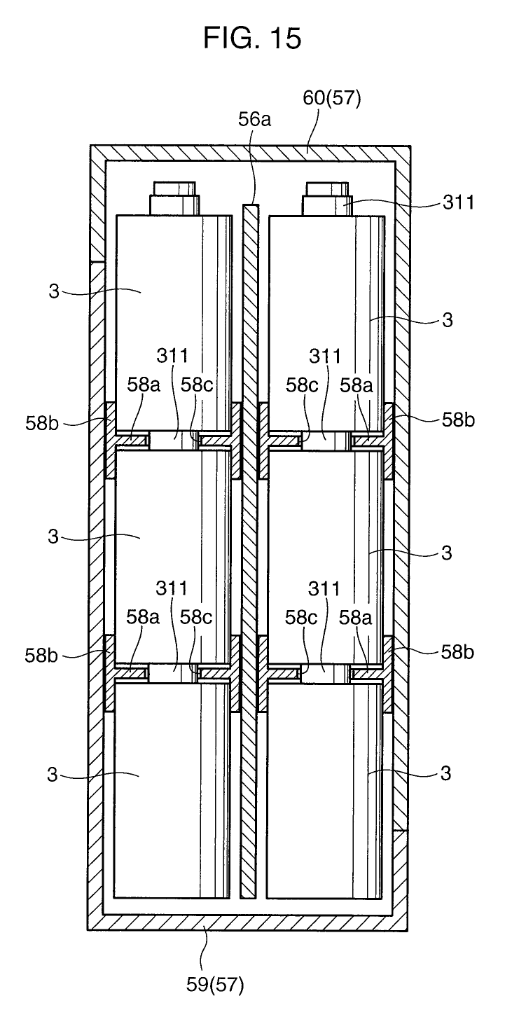

FIG. 13 is a side view showing the entire construction of an electric bicycle 52 mounted with a battery pack 51. FIG. 14 is an exploded perspective view of the battery pack 51 of FIG. 13. FIG. 15 is a section along XV-XV of FIG. 14.

As shown in FIGS. 13 to 15, the electric bicycle 52 is provided with a bicycle body 53, a holder 54 provided on this bicycle body 53 and the battery pack 51 mounted in this holder 54, wherein an unillustrated motor is driven by the power of the battery pack 51.

The battery pack 51 includes an assembled battery 55 as an assembly of twelve cells 3, a cell partition wall 56 for partitioning between the respective cells 3 and a housing 57 for accommodating the assembled battery 55 and the cell partition wall 56.

The assembled battery 55 is such that four sets are connected in parallel with each set of three cells connected in series (a state where two sets are connected in parallel is shown in FIG. 14). Further, the assembled battery 55 includes adapters 58 provided between the respective cells 3 connected in series.

Each adapter 58 is for connecting a positive electrode side end surface of the cell 3 and a negative electrode side end surface of the adjacent cell 3. Specifically, the adapter 58 includes a disk-shaped bottom portion 58a and a side wall portion 58b standing from the peripheral edge of this bottom portion 58a toward both top and bottom sides, wherein an end portion of the cell 3 is held inside this side wall portion 58b. The bottom portion 58a is formed with a through hole 58c. The through hole 58c is for permitting the passage of the positive electrode terminal 311 of the cell 3 to bring the positive electrode terminal 311 of the cell 3 into contact with the negative electrode terminal of the adjacent cell 3.

The cell partition wall 56 is a cross-shaped member including four partition plates 56a to be arranged between the sets of the cells 3.

The housing 57 includes a battery accommodating part 59 and a battery pack lid 60 and forms a hollow container having the shape of substantially rectangular parallelepiped as a whole by assembling these battery accommodating part 59 and the battery pack lid 60. Specifically, the battery accommodating part 59 and the battery pack lid 60 are so shaped as to divide the hollow container into L-shaped sections when viewed sideways. By arranging the cell partition wall 56 in the battery accommodating part 59, accommodating the sets of the respective cells 3 in the sections divided by this cell partition wall 56 and mounting the battery pack lid 60 on this battery accommodating part 59, the assembled battery 55 and the cell partition wall 56 are accommodated in the housing 57.

Although not shown in the battery pack 51, a thermal expansion material is respectively attached to the inner walls of the battery accommodating part 59 and the battery pack lid 60 and the outer surfaces of the cell partition wall 56.

Also in the battery pack 51, even if the cell 33 generates heat due to an internal short circuit or overcharge and a gas is released from the interior of the cell 3, the spread of combustion to the housing 57 and the other cells 3 can be suppressed and the damage of the battery pack 51 can be reduced since this cell 3 is thermally separated by the thermal expansion material.

A modification of the battery pack and a hybrid car mounted with such a battery pack are described below.

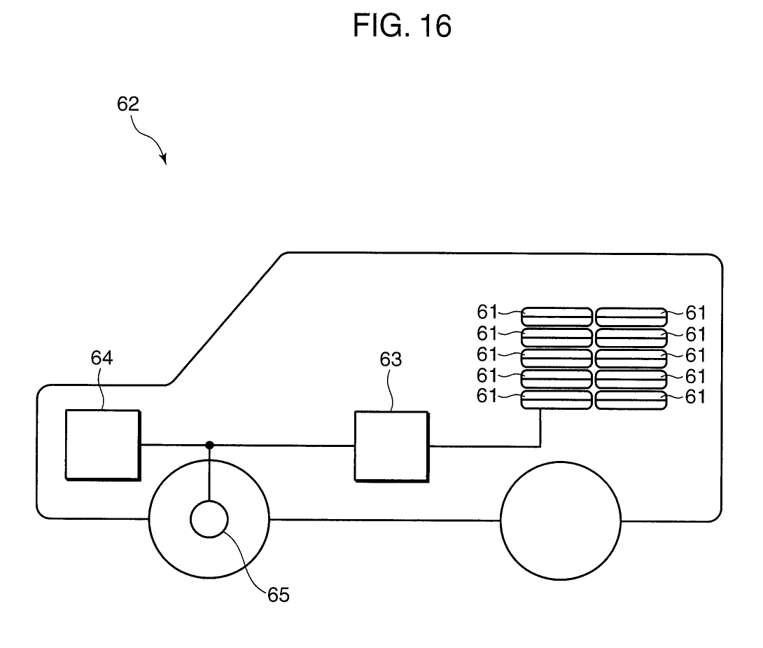

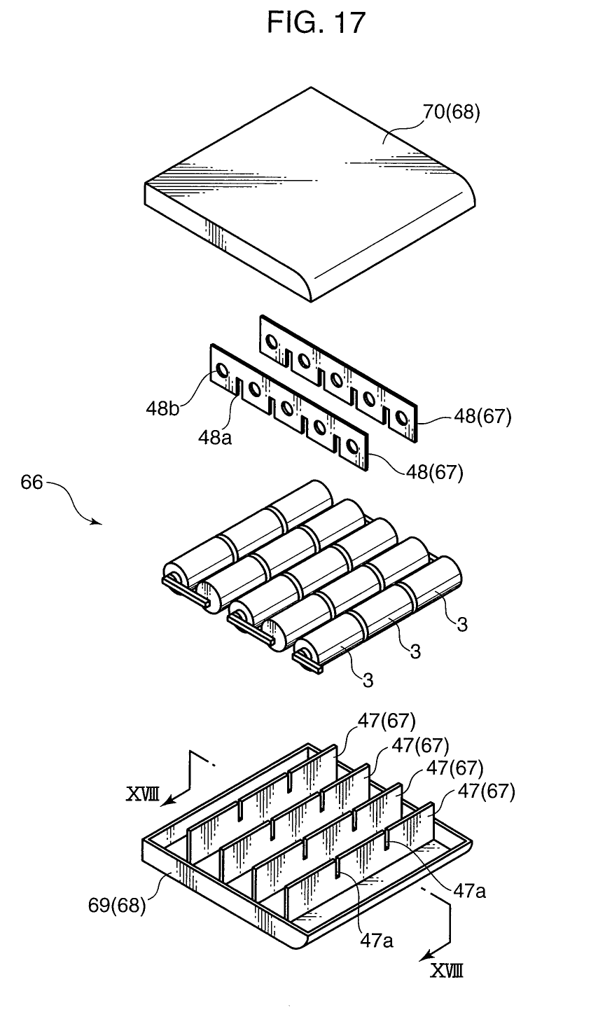

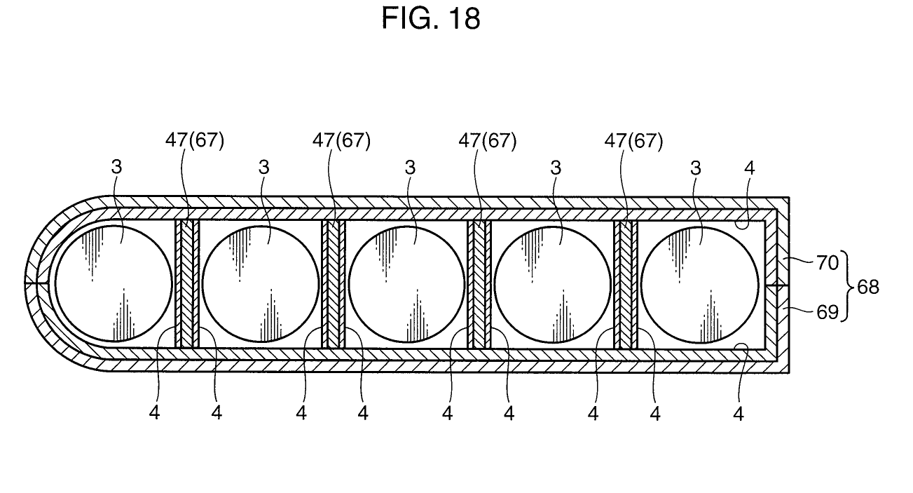

FIG. 16 is a side view showing the entire construction of a hybrid car mounted with a battery pack 61. FIG. 17 is an exploded perspective view of the battery pack 61 of FIG. 16. FIG. 18 is a section along XVIII-XVIII of FIG. 17.

The hybrid car 62 is provided with a plurality of battery packs 61, a motor 63 to be driven according to the electric power of these battery packs 61, an engine 64 and an axle 65 to be driven and rotated upon receiving power from the motor 63 or engine 64. This hybrid car 62 charges the respective battery packs 61 by regenerating kinetic energy during braking and the like by using the motor 63.

The battery pack 61 includes an assembled battery 66 as an assembly of fifteen cells 3, a cell partition wall 67 for partitioning between the respective cells 3 and a housing 68 for accommodating the assembled battery 66 and the cell partition wall 67.

The assembled battery 66 is such that five sets are connected in series with each set of three cells 3 connected in series.

The cell partition wall 67 includes the aforementioned first partition plates 47 (see FIG. 9) and second partition plates 48. Specifically, the cell partition wall 67 includes four first partition plates 47 and two second partition plates 48 to divide the interior of the housing 68 into fifteen chambers.

The housing 68 includes a battery accommodating part 69 and a battery pack lid 70. The battery accommodating part 69 and the battery pack lid 70 are respectively in the form of bottomed containers and assembled with the opening ends thereof held in contact, thereby being able to accommodate the assembled battery 66 and the cell partition wall 67.

As shown in FIG. 18, a thermal expansion material 4 is respectively attached to the inner walls of the battery accommodating part 69 and the battery pack lid 70 and the outer surfaces of the cell partition wall 67 in the battery pack 61.

Also in the battery pack 61, even if the cell 33 generates heat due to an internal short circuit or overcharge and a gas is released from the interior of the cell 3, the spread of combustion to the housing 68 and the other cells 3 can be suppressed and the damage of the battery pack 61 can be reduced since this cell 3 is thermally separated by the thermal expansion material 4.

Although the notebook personal computer, the electric bicycle and the hybrid electric car are described with reference to FIGS. 9 to 18, mobile phones and audio players used with a single cell, electric devices and electronic devices such as digital still cameras and electric tools as examples used with a plurality of cells can be cited as the device mounted with the battery pack.

As described above, according to the above embodiment, the thermal expansion material 4 reduces the internal clearances in the housing when the temperature of the cell 3 rises and a high-temperature gas is released from the inside of the cell 3. As a result, the cell 3 having a high temperature is thermally separated, whereby adverse effects on the housing and the adjacent normal cells can be suppressed and the safety of the battery pack can be improved.

### Example 1

The cell 3 shown in FIG. 6 was produced as follows. An aluminum foil current collector having a positive electrode mixture applied thereto was used as the positive plate 301. A copper foil current collector having a negative electrode mixture applied thereto was used as the negative plate 303. The thickness of the separator 305 was 25 μm and the positive electrode lead current collector 302 and the aluminum foil current collector were laser-welded. Further, the negative electrode lead current collector 304 and the copper foil current collector were resistance-welded. The negative electrode lead current collector 304 was electrically connected to the bottom portion of the metallic bottomed case 308 by resistance welding. The positive electrode lead current collector 302 was electrically connected with a metal filter of the sealing plate 310 including an explosion-proof valve from the open end of the metallic bottomed case 308 by laser welding. A nonaqueous electrolyte was poured through the opening end of the metallic bottomed case 308. A seat was formed by forming a groove in the open end of the metallic bottomed case 308, the positive electrode lead current collector 302 was bent and the outer gasket 309 made of resin and the sealing plate 310 were mounted on the seat of the metallic bottomed case 308 and then the open end of the metallic bottomed case 308 was swaged over the entire circumference to be sealed.

(1) Fabrication of the Positive Plate 301

The positive plate 301 is fabricated as follows. 85 weight parts of lithium cobaltate powder as a positive electrode mixture, 10 weight parts of carbon powder as an electroconductive agent, and an amount of an N-methyl-2-pyrrolidone (hereinafter, abbreviated as “NMP”) solution of polyvinylidene fluoride (hereinafter, abbreviated as “PVDF”) as a binder corresponding to 5 weight parts of PVDF are mixed. After this mixture is applied to an aluminum foil current collector having a thickness of 15 μm and dried, the current collector is rolled to fabricate the positive plate 301 having a thickness of 100 μm.

(2) Fabrication of the Negative Plate 303

The negative plate 303 is fabricated as follows. 95 weight parts of artificial graphite powder as a negative electrode mixture and an amount of an NMP solution as a binder corresponding to 5 weight parts of PVDF are mixed. After this mixture is applied to a copper foil current collector having a thickness of 10 μm and dried, the current collector is rolled to fabricate the negative plate 303 having a thickness of 110 μm.

(3) Preparation of the Nonaqueous Electrolyte

The nonaqueous electrolyte is prepared as follows. Ethylene carbonate and ethyl methyl carbonate are mixed at a volume ratio of 1:1 as a nonaqueous solvent, and lithium hexafluorophosphate (LiPF₆) is solved as a solute into the mixture to obtain a concentration of 1 mol/L. 15 ml of the thus prepared nonaqueous electrolyte is used.

(4) Fabrication of the Sealed Secondary Cell 3

After the positive plate 301 and the negative plate 303 were wound with the separator 305 having a thickness of 25 μm arranged therebetween to form the cylindrical polar plate group 312, the polar plate group 312 was inserted into the metallic bottomed case 308 and the case 308 was sealed to obtain the sealed nonaqueous electrolyte secondary cell 3. This cell was a cylindrical cell having a diameter of 25 mm and a height of 65 mm, and a designed capacity thereof was 2000 mAh. The completed cell 3 was covered with a heat shrinkable tube made of polyethylene terephthalate and having a thickness of 80 μm as the cell can insulator 33 up to an outer edge portion of the top surface, and the tube was thermally shrunk by hot air of 90° C. to complete the cell.

(5) Fabrication of the Assembled Battery

Nine cylindrical lithium ion secondary cells 3 constructed as described above were arranged as shown in FIG. 7 and connected by the connection plates 32 made of nickel and having a thickness of 0.2 mm. Further, the connection leads 34 for electrically connecting the connected cells 3 with the battery pack terminals 24 were attached to the cells 3 to fabricate the assembled battery 31. This assembled battery 31 was accommodated into the battery accommodating part 21 and the battery pack lid 22 was welded to the outer peripheral portion of the battery accommodating part.

### Example 1

As shown in FIGS. 1 and 2, the cells 3 were arranged in the housing 2 and Fire Barrier (moldable putty MPP-4S) produced by Sumitomo 3M, Ltd., i.e. the thermal expansion material 4 was arranged between the inner wall surfaces of the battery accommodating part 21 and the battery pack lid 22 and the respective cells 3 to fabricate the battery pack of Example 1.

### Example 2

As shown in FIGS. 1 and 3, the cells 3 were arranged in the housing 2 and Fire Barrier (moldable putty MPP-4S) produced by Sumitomo 3M, Ltd. was held in close contact with the outer surfaces of the respective cells 3 to cover the outer surfaces of the respective cells 3, thereby fabricating a battery pack of Example 2.

### Example 3

70 weight % of polycarbonate used as a housing material and 30 weight % of expandable graphite powder (Moehen Z MZ-600) produced by Air Water Inc. were mixed and the battery accommodating part 21 and the battery pack lid 22 shaped as in Example 1 were injection molded using this mixture. Using the battery accommodating part 21 and the battery pack lid 22, the cells 3 were arranged in the housing 2 as shown in FIGS. 1 and 4 to fabricate a battery pack of Example 3.

### Example 4

As shown in FIGS. 1 and 5, Fire Barrier (moldable putty MPP-4S) produced by Sumitomo 3M, Ltd. was filled in clearances between the cells 3 and the inner walls of the housing 2 to fabricate a battery pack of Example 4.

### Example 5

The battery pack of Example 2 in which the thermal expansion material was replaced by Accera Coat produced by Access Co., Ltd. to fabricate a battery pack according to Example 5.

### Comparative Example 1

A construction similar to Example 1 was employed (the cells were arranged as in Example 1) except that Fire Barrier (moldable putty MPP-4S) produced by Sumitomo 3M, Ltd. was not used to fabricate a battery pack of Comparative Example 1.

### Comparative Example 2

Glass wool (Hypermagwool Mag Rouge produced by Mag Co., Ltd.) was filled as a heat insulating material in the clearances between the cells 3 and the inner walls of the housing 2 to fabricate a battery pack of Comparative Example 2.

The following evaluations were conducted for the respective battery packs obtained in the above Examples and Comparative Examples.

(6) Discharge Test

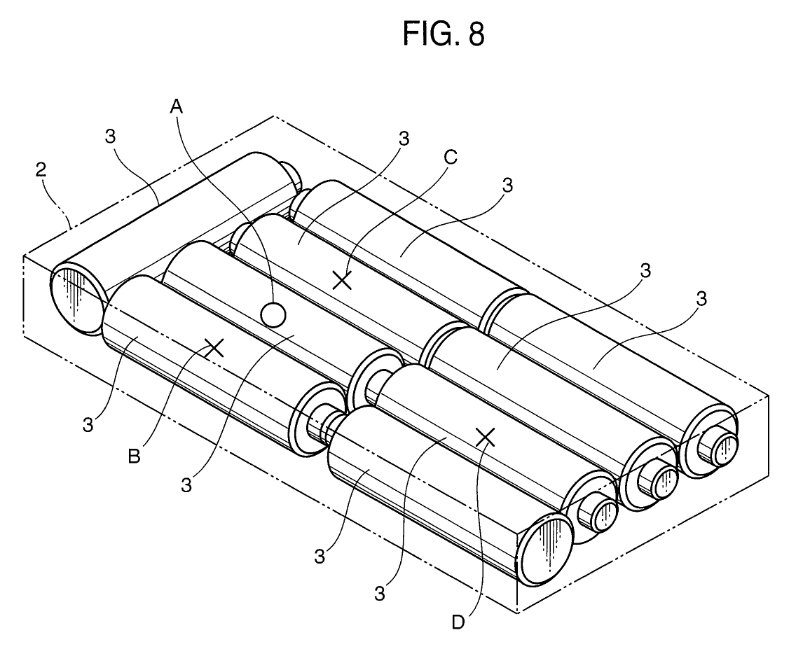

The completed battery packs were charged up to 12.6 V with a maximum current and a charge end current during the charge respectively set to 4.5A and 0.15 A. Discharge was performed at a current of 6 A and a end voltage of 9 V and, simultaneously, surface temperatures of four cells A, B, C and D shown in FIG. 8 were measured to judge heat influence caused by the discharge.

(7) Nail Penetration Test

Although the completed battery packs are normally charged up to 12.6 V when a maximum current and a charge end current during the charge were set to 4.5 A and 0.15A, overcharge protection circuits of the battery packs and current interrupt devices (CIDs) of the cells were bypassed to charge the battery packs with constant current, constant voltage up to 13.5V. Thereafter, an iron nail having a diameter of 2.5 mm was used and so penetrated into the battery pack as to pass a central part of the cell (A in FIG. 8) inside with respect to a height direction and a diameter direction at a speed of 5 mm/s at a temperature of 20° C. It was observed whether or not combustion was spread to the other cells not penetrated with the nail due to a high-temperature state of the cell penetrated with the nail. Simultaneously, the surface temperatures of the four cells A, B, C and D shown in FIG. 8 were measured to judge heat influence.

The discharge test and the nail penetration test was conducted for the above Examples 1 to 5 and Comparative Examples 1, 2, and peak values of the temperatures measured at the positions A, B, C and D are shown in TABLE-1 below. The temperatures of the respective cells were 20° C. equal to ambient temperature in a state before the nail penetration test was conducted.

TABLE 1

| | Discharge Test | | | | Nail Penetration Test | | | | |
|---|---|---|---|---|---|---|---|---|---|
| | A | B | C | D | SC | A | B | C | D |
| Example 1 | 42° C. | 40° C. | 43° C. | 42° C. | NO | 841 | 132 | 145 | 138 |
| Example 2 | 41° C. | 39° C. | 42° C. | 41° C. | NO | 850 | 140 | 149 | 143 |
| Example 3 | 39° C. | 37° C. | 40° C. | 38° C. | NO | 820 | 145 | 152 | 149 |
| Example 4 | 38° C. | 36° C. | 39° C. | 28° C. | NO | 830 | 138 | 145 | 142 |
| Example 5 | 40° C. | 40° C. | 41° C. | 41° C. | NO | 845 | 138 | 141 | 139 |
| Comp. Example 1 | 38° C. | 36° C. | 39° C. | 37° C. | TC | 860 | 823 | 876 | 853 |
| Comp. Example 2 | 63° C. | 65° C. | 67° C. | 64° C. | NO | 853 | 129 | 138 | 135 |

Note)
SC denotes spread of combustion, TC denotes total combustion.

Spread of combustion in TABLE-1 means the presence or absence of spread of combustion to other cells other than the one penetrated with the nail. If the spread of combustion occurs, the weight of the cell decreases by burning the combustion of electrolyte and the like in the cell. Whether or not the spread of combustion had occurred was judged by comparing the weights of the respective cells 3 before and after the nail penetration test. In other words, the spread of combustion was judged to have occurred if the weight was decreased after the nail penetration test.

As shown in the above TABLE-1, the influence on the other cells is understood to be significantly reduced by arranging the thermal expansion material in the pack.

Specifically, upon comparing Examples 1 to 5 and Comparative Example 2, the packs of Examples have smaller temperature rises during normal charge and discharge since being able to efficiently release waste heat generated by discharge to the outsides of the packs. In contrast, very high temperatures of the cells can be confirmed in the pack of Comparative Example 2 since heat cannot be released due to the heat insulating material. Thus, in the battery pack of Comparative Example 2, heat remains in the pack, whereby battery characteristics may be possibly degraded.

At the time of the nail penetration test, the spread of combustion could be suppressed in the battery packs of Examples 1 to 5 and Comparative Example 2, whereas the combustion was spread to all the cells in the battery pack of Comparative Example 1. This is because the temperature of the cell rose and the surrounding thermal expansion material 4 expanded in the packs of Examples, whereby the cell whose temperature had risen could be thermally separated to suppress the spread of combustion.

Since the thermal expansion material was arranged in all the clearances in the housing in the pack of Example 4, the deformation of the housing caused by thermal expansion was confirmed after the nail penetration test. From this result, it is understood that clearances of certain degrees are preferably ensured in the housing in consideration of a volumetric increase by expansion.

These thermal expansion materials are most effective when containing thermally expandable graphite. The thermally expandable graphite also has a flame retardant effect since it absorbs heat during expansion and exhausts an inert gas. Thus, it particularly effectively acts to suppress the spread of combustion of the battery pack.

It is confirmed that the effect of suppressing the spread of combustion is improved by simultaneously including a flame retardant such as zinc borate or ammonium polyphosphate and a phosphate-based extinguishing agent in the thermal expansion material.

Although the thermal expansion material in the form of putty is used in this embodiment, a thermal expansion material in the form of paint or paste may be coated on the housings and the cells or a molded or particulated thermal expansion material may be filled in the clearances.

Next, examples of battery-mounted devices are described.

(1) Fabrication of a Positive Plate

A saturated aqueous solution was prepared by adding sulfate containing Co and Al at a specified ratio to a NiSO₄ aqueous solution. While this saturated aqueous solution was agitated, a sodium hydroxide solution was allowed to slowly drip into this saturated solution. In this way, the saturated solution was neutralized, with the result that a precipitate of ternary nickel hydroxide Ni_{0.7}Co_{0.2}Al_{0.1}(OH)₂ could be produced (coprecipitation method). The produced precipitate was washed with water after being filtered, and then dried at 80° C. An average particle diameter of the obtained nickel hydroxide was about 10 μm.

The obtained Ni_{0.7}Co_{0.2}Al_{0.1}(OH)₂ was heat-treated at 900° C. for 10 hours in the atmosphere to obtain nickel oxide Ni_{0.7}Co_{0.2}Al_{0.1}O. At this time, the obtained nickel oxide Ni_{0.7}Co_{0.2}Al_{0.1}O was diffracted using a powder X-ray diffraction method to confirm that the nickel oxide Ni_{0.7}Co_{0.2}Al_{0.1}O was single-phase nickel oxide. Lithium hydroxide monohydrate was added to the nickel oxide Ni_{0.7}Co_{0.2}Al_{0.1}O so that the sum of the atomic number of Ni, that of Co and that of Al was equivalent to the atomic number of Li, and the resultant was heat-treated for 10 hours at 800° C. in dry air to obtain lithium nickel composite oxide LiNi_{0.7}Co_{0.2}Al_{0.1}O₂.

Upon diffracting the obtained lithium nickel composite oxide LiNi_{0.7}Co_{0.2}Al_{0.1}O₂ using the powder X-ray diffraction method, it was confirmed that this lithium nickel composite oxide LiNi_{0.7}Co_{0.2}Al_{0.1}O₂ had a single-phase hexagonal layered structure and Co and Al were solid-dissolved in this lithium nickel composite oxide LiNi_{0.7}Co_{0.2}Al_{0.1}O₂. After being pulverized, the lithium nickel composite oxide LiNi_{0.7}Co_{0.2}Al_{0.1}O₂ was classified and reduced to powder. An average particle diameter of this powder was 9.5 μM and a specific surface area thereof calculated in accordance with a BET method was 0.4 m²/g.

3 kg of the obtained lithium nickel composite oxide, 90 g of acetylene black and 1 kg of a PVDF solution were kneaded in a planetary mixer together with an appropriate amount of N-methyl-2-pyrrolidone (NMP, N-methylpyrrolidone) to prepare a positive electrode mixture in a slurry state. This positive electrode mixture was applied onto an aluminum foil having a thickness of 20 μm and a width of 150 mm. At this time, an uncoated portion having a width of 5 mm was formed at one widthwise end of the aluminum foil. Thereafter, the positive electrode mixture was dried to form a positive electrode mixture layer on the aluminum foil. After the positive electrode mixture layer and the aluminum foil were pressed so that the sum of the thickness of the positive electrode mixture layer and that of the aluminum foil was 100 μm, a positive plate Al for a cylindrical lithium ion secondary cell of 18650 size and a positive plate for a cell with a tabless current collecting structure were fabricated. The polar plate for the cell with the tabless current collecting structure was cut so that the width thereof was 105 mm and that of the positive electrode material coated portion was 100 mm, thereby fabricating a positive plate B1 with the tabless current collecting structure.

(2) Fabrication of a Negative Plate

3 Kg of artificial graphite, 75 g of an aqueous solution (weight of solid content was 40 weight %) containing rubber particles (binder) made of a styrene-butadiene copolymer and 30 g of carboxymethylcellulose (CMC) were kneaded in a planetary mixer together with an appropriate amount of water to prepare a negative electrode mixture in a slurry state. This negative electrode mixture is applied onto a copper foil having a thickness of 10 μm and a width of 150 mm. At this time, an uncoated portion (exposed portion) having a width of 5 mm was formed at one widthwise end of the copper foil. Thereafter, the negative electrode mixture was dried to form a negative electrode mixture layer on the copper foil. After the negative electrode mixture layer and the copper foil were pressed so that the sum of the thickness of the negative electrode mixture layer and that of the copper foil was 110 μM, a negative plate A2 for the cylindrical lithium ion secondary cell of 18650 size and a negative plate for the cell with the tabless current collecting structure were fabricated. The polar plate for the cell with the tabless current collecting structure was cut so that the width thereof was 110 mm and that of the negative electrode mixture coated portion was 105 mm, thereby fabricating a negative plate B2 with the tabless current collecting structure.

(3) Fabrication of a Cylindrical Sealed Cell of 18650 Size

A cylindrical sealed cell A of 18650 size having a nominal capacity of 2.4 Ah was fabricated by a method similar to the one for the cylindrical cells used in Example 1 except that the positive plate Al and the negative plate A2 were used.

(4) Fabrication of a Sealed Cell with a Tabless Current Collecting Structure

A separator made of polyethylene was sandwiched between the fabricated positive electrode and negative electrode such that the exposed portion of the positive electrode and the exposed portion of the negative electrode projected in opposite directions from end surfaces of the separator. Thereafter, the positive electrode, the negative electrode and the separator were wound into a cylindrical shape.

Subsequently, reinforcing members were formed on the exposed portions.

Specifically, EC as a solvent of a nonaqueous electrolyte was heated to 50° C. and melted to obtain liquid EC. A 10 mm part of the positive electrode from the end surface of the exposed portion was immersed in the liquid EC. Thereafter, they were left at room temperature as they were to solidify the liquid EC. Similarly, a 10 mm part of the negative electrode from the end surface of the exposed portion was immersed in the liquid EC. Thereafter, they were left at room temperature as they were to solidify the liquid EC. In this way, the reinforcing members were formed on the exposed portions of the positive and negative electrodes, whereby an electrode group could be formed.

Thereafter, the current collecting structure was formed.

Specifically, a current collecting plate made of aluminum was, first of all, pressed against the end surface of the exposed part of the positive electrode and laser light was irradiated in a vertically and horizontally crossed manner. In this way, the aluminum current collecting plate could be bonded to the end surface of the exposed portion of the positive electrode.

Further, a circular portion of a current collecting plate made of nickel was pressed against the end surface of the exposed part of the negative electrode and laser light was irradiated in a vertically and horizontally crossed manner. In this way, the nickel current collecting plate could be bonded to the end surface of the exposed portion of the negative electrode, whereby the current collecting structure was formed.

The formed current collecting structure was inserted into a cylindrical case made of nickel-plated iron. Thereafter, a tab portion of the nickel current collecting plate was bent and resistance-welded to a bottom part of the case. Further, a tab portion of the aluminum current collecting plate was laser-welded to a sealing plate and the nonaqueous electrolyte was poured into the case. At this time, the nonaqueous electrolyte was prepared by dissolving lithium hexafluorophosphate (LiPF₆) as a solute into a mixed solvent, in which EC and ethylmethyl carbonate (EMC) were mixed at a volumetric ratio of 1:3, at a concentration of 1 mol/dm³. Thereafter, the sealing plate was swaged to seal the case. In this way, there was fabricated a cylindrical sealed lithium ion secondary cell B having a diameter of 32 mm and a height of 120 mm as a sealed cell with a tabless current collecting structure having a nominal capacity of 5 Ah.

### Example 6

Using the cylindrical sealed cells A of 18650 size, a battery pack mountable in a commercially available notebook PC as a battery-mounted device as shown in FIGS. 9 to 12 was experimentally produced. Specifically, the battery pack 40 included a thermal expansion material (Fire Barrier (moldable putty MPP-4S) produced by Sumitomo 3M, Ltd.) on inner wall parts of the housing 46 and at the opposite sides of the cell partition wall 45.

### Example 7

Using the sealed cells B with the tabless current collecting structure, a battery pack mountable in the electric bicycle 52 as a battery-mounted device as shown in FIGS. 13 to 15 was experimentally produced. Specifically, the battery pack 51 included a thermal expansion material (Fire Barrier (moldable putty MPP-4S) produced by Sumitomo 3M, Ltd.) on inner wall parts of the housing 57 and at the opposite sides of the cell partition wall 56.

### Comparative Example 3

A battery pack including no thermal expansion material on inner wall parts of a housing and at the opposite sides of a cell partition wall was prepared as a battery pack of Comparative Example 3.

### Comparative Example 4

A battery pack including no thermal expansion material on inner wall parts of a housing and at the opposite sides of a cell partition wall was prepared as a battery pack of Comparative Example 4.

The following evaluations were conducted for the respective battery packs obtained in the above Examples and Comparative Examples.

(i) Discharge Test

The completed battery-mounted devices were placed at an ambient temperature of 20° C. and all the cells were charged up to 4.2 V with a maximum current and a charge end current per cell during the charge respectively set to 0.7 It (1 It is 5 A when the cell capacity is 5 Ah) and 0.05 It. Further, discharge was performed at a current of 5 It and an end voltage of 2.5 V per cell. Simultaneously, surface temperatures of the cells were measured to judge heat influence caused by the discharge.

(ii) Overcharge Test

The completed battery-mounted devices were placed at an ambient temperature of 20° C. and all the cells were charged up to 4.2 V with a maximum current and a charge end current per cell during the charge respectively set to 0.7 It (1 It is 5 A when the cell capacity is 5 Ah) and 0.05 It. Although a charge of 4.2V is normal, only one of the cells in each battery pack was charged with constant current, constant voltage up to 10 V with a maximum current set to 3 It by bypassing an overcharge protection circuit of the battery pack and a current interrupt device (CID) of the cell, whereby an overcharge test was conducted. In this way, only one cell in the battery pack was forcibly brought to a high-temperature state of 200° C. or higher and evaluation was made to confirm the influence on the other cells in the pack.

In the discharge test, no large heat influence was observed except the cell temperatures were, on the average, higher by 2 to 3° C. in Examples 6 and 7 than in Comparative Examples 3, 4. Thus, it could be confirmed that substantially the same heat release as in Comparative Examples could be performed.

In the overcharge test, a chain reaction of the adjacent cells reaching a high-temperature state of 200° C. or higher was confirmed in Comparative Examples 3 and 4. Thereafter, ignition was confirmed in the housings of the battery packs and the battery-mounted devices. This is because high heat from the overcharged cell induced the spread of combustion to the adjacent cells, the housings of the battery packs and the battery-mounted devices. In contrast, in Examples 6 and 7, only the overcharged cells reached a high-temperature state, and no spread of combustion to the adjacent cells and the housings of the battery packs was observed.

The spread of combustion to the cells other than the overcharged one could be suppressed by a heat insulating effect of the thermal expansion material displayed only at an abnormally high temperature.

Although the test was conducted to confirm the spread of combustion of only the battery packs this time, the spread of combustion to the cells and the pack housings is suppressed also when the battery packs are mounted in the device bodies. Therefore, the damage of the device bodies is also suppressed to a minimum level.

By using the thermal expansion material in the battery pack in this way, a safe battery-mounted device can be realized which has a good waste heat effect in normal use and displays a heat insulating property only in the event of an abnormality in a cell to prevent the spread of combustion to adjacent cells and a housing of a battery pack and the battery-mounted device.

The above specific embodiments mainly embrace inventions having the following constructions.

A battery pack according to one aspect of the present invention comprises a cell, a housing for accommodating the cell and a thermal expansion section capable of reducing internal clearances between the cell and the housing upon an application of heat.

According to the present invention, if the cell reaches a high temperature and a high-temperature gas is exhausted from the inside of the cell, the thermal expansion section reduces the internal clearances in the housing of the battery pack. As a result, the high-temperature cell is thermally separated, whereby adverse effects on the housing and adjacent normal cells can be suppressed and the safety of the battery pack can be improved.

Specifically, the thermal expansion section is made of at least one of a thermal expansion material covering at least parts of the outer surfaces of the cell, a thermal expansion material used at least in a part of a cell partition wall or the housing and a thermal expansion material used at least in a part of a covering material covering the inner walls of the housing.

According to this construction, the thermal expansion section normally efficiently releases heat generated during the use of the cell to the outside of the pack as a material with good conductivity, thereby maintaining the cell temperatures at a normal temperature. Even if the cell reaches a high-temperature state in the battery pack and a high-temperature gas is exhausted from a safety valve or the like due to a temperature rise of the cell, the thermal expansion section thermally expands near a high-temperature part, thereby being able to deprive heat of the high-temperature part and the high-temperature gas, shut off oxygen and suppress combustion to a minimum level. Therefore, adverse effects on the housing of the battery pack and the adjacent normal cells can be suppressed.

As another function, thermal conductivity per unit volume decreases by the expansion of the thermal expansion material. Thus, the high-temperature cell is thermally separated to suppress adverse effects on the cells and the battery pack.

The thermal expansion material needs not always entirely cover the housing and the outer surfaces of the cells, and may be used only in regions where the cells are most proximate to each other and on wall surfaces in the pack where the high-temperature exhaust gas passes and/or touches. In this way, space saving and cost saving of the pack can be realized.

The thermal expansion material preferably contains expandable graphite. The expandable graphite also acts as a flame retardant material because it absorbs heat and generates an inert gas during expansion and effectively acts to suppress the spread of combustion of the pack.

The thermal expansion material preferably contains a material which is decomposed at a high temperature to generate a gas. Magnesium carbonate, sodium hydrogen carbonate, ammonium dihydrogen phosphate, aluminum hydroxide, dinitroso pentamethylene tetramine; azodicarbonamide, oxybis benzenesulfonyl hydrazide, hydrazodicarbonamide, 5,5′-bis-H-tetrazole and the like are cited as the material that is decomposed at a high temperature to generate a gas. By combining these materials with resins such as polypropylene, polyethylene and polyurethane, the thermal expansion materials can be made.

According to the battery pack and the battery-mounted device having the above constructions, the thermal expansion material expands in the housings of the battery pack and the battery-mounted device to fill up the internal clearances if the cell reaches a high temperature and a high-temperature gas is exhausted from the inside of the cell. As a result, the high-temperature cell is thermally separated to suppress adverse effects on the housings and the adjacent normal cells and further to reduce a possibility of affecting the battery pack and the battery-mounted device.

### INDUSTRIAL APPLICABILITY

Since a battery pack according to the present invention exhibits high safety without degrading characteristics in normal use even when an abnormality occurs in a cell in the battery pack and the cell reaches a high-temperature state, it is useful as a power supply of an electronic device or the like.

1. A battery pack, comprising:
a cell;
a housing for accommodating the cell; and
a thermal expansion section capable of reducing internal clearances between the cell and the housing upon an application of heat.

2. A battery pack according to claim 1, wherein the thermal expansion section is made of a thermal expansion material covering at least parts of the outer surfaces of the cell.

3. A battery pack according to claim 1 or 2, further comprising a cell partition wall provided in the housing, wherein:
the thermal expansion section is made of a thermal expansion material used at least in a part of the housing and the cell partition wall.

4. A battery pack according to claim 1, wherein the thermal expansion section is made of a thermal expansion material used at least in a part of a covering material covering the inner walls of the housing.

5. A battery pack according to claim 2, wherein the thermal expansion material is a material containing thermally expandable graphite.

6. A battery pack according to claim 2, wherein the thermal expansion material includes a material which generates a gas during expansion.

7. A battery-mounted device, characterized by being mounted with a battery pack according to claim 1.
